(19) United States
(12) Patent Application Publication
(10) Pub. No.: US 2009/0207915 A1
(43) Pub. Date: Aug. 20, 2009

(54) SCALABLE MOTION SEARCH RANGES IN MULTIPLE RESOLUTION MOTION ESTIMATION FOR VIDEO COMPRESSION

(75) Inventors: Yong Yan, Austin, TX (US); Yolanda Prieto, Coral Gables, FL (US)

Correspondence Address: Huffman Law Group, P.C., 1900 Mesa Ave., Colorado Springs, CO, 80906, US

(73) Assignee: FREESCALE SEMICONDUCTOR, INC., Austin, TX (US)

(21) Appl. No.: 12/032,394

(22) Filed: Feb. 15, 2008

(51) Int. Cl. H04N 11/02

(52) U.S. Cl. 375/240.16; 375/E07.076

(57) ABSTRACT

A method of performing motion search for video including providing at least one motion search offset range for multiple search range scale levels and resolution levels, monitoring at least one operating metric, selecting a search range scale level, and performing motion search for selected resolution levels using search windows determined by the offset ranges at the selected search range scale level. A video encoder including a memory for storing motion search offset ranges for multiple resolution levels and multiple levels of a search range scale, and control logic for controlling motion estimation. The control logic monitors at least one operating metric, selects a search range scale level, and controls motion search at selected resolution levels using search windows determined by the offset ranges at the selected search range scale level. The offset range and resolution levels may be modified based on the operating metrics and/or motion search comparison metrics.

### BACKGROUND OF THE INVENTION

1. Field of the Invention

The present invention relates in general to video information processing, and more specifically to scalable motion search ranges in multiple resolution motion estimation for video compression.

2. Description of the Related Art

The Advanced Video Coding (AVC) standard, Part 10 of MPEG4 (Motion Picture Experts Group), otherwise known as H.264, includes advanced compression techniques that were developed to enable transmission or storage of video signals at a higher coding efficiency as compared to the earlier standards, such as H.263. The standard defines the syntax of the encoded video bitstream along with a method of decoding the bitstream. Each video frame is subdivided and encoded at the macroblock (MB) level, where each MB is a 16×16 block of pixel values. Each MB is encoded in “intra” mode in which a prediction MB is formed based on reconstructed MBs in the current frame, or “inter” mode in which a prediction MB is formed based on reference MBs from one or more reference frames. The intra coding mode applies spatial information within the current frame in which the prediction MB is formed from samples in the current frame that have been previously encoded, decoded and reconstructed. The inter coding mode utilizes temporal information from previous and/or future reference frames to estimate motion to form the prediction MB. The video information is typically processed and transmitted in slices, in which each video slice incorporates one or more macroblocks.

Motion Estimation (ME) is used in almost all hybrid (spatial and temporal) based video compression techniques, including those based on and compatible with the MPEG-x or H.26× standards. As the video resolution increases, the amount of displacement between consecutive frames in terms of pixel positions increases. As a result, the motion vector search range increases. A large search range usually provides better coding efficiency for high resolution video. A large search range, however, introduces substantially increased computational complexity because the ME process consumes approximately 40% to 60% computational loads for an encoder.

### BRIEF DESCRIPTION OF THE DRAWINGS

The benefits, features, and advantages of the present invention will become better understood with regard to the following description, and accompanying drawings where:

FIG. 1 is a figurative block diagram illustrating motion search of video information according to an exemplary embodiment;

FIG. 2 is a figurative block diagram illustrating scaled motion search of video information using multiple resolution levels according to an exemplary embodiment;

FIG. 3 is a simplified block diagram of an encoder for performing scaled motion searches according to an exemplary embodiment;

FIG. 4 is a table illustrating an exemplary embodiment of the motion search offset ranges of FIG. 3;

FIG. 5 is a flowchart diagram illustrating operation of the encoder of FIG. 3 for performing scaled motion searches according to one embodiment; and

FIG. 6 is a diagram of a replacement block for the flowchart of FIG. 5 for an alternative embodiment in which the motion search comparison metric determined at a lower resolution level is used to adjust or otherwise determine the size of the motion search window at a higher resolution level.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present disclosure describes exemplary embodiments of video information processing systems. It is intended, however, that the present disclosure apply more generally to any of various types of “video information” including video sequences (e.g. MPEG) or image sequencing information or the like. The term “video information” as used herein is intended to apply to any video or image sequence information.

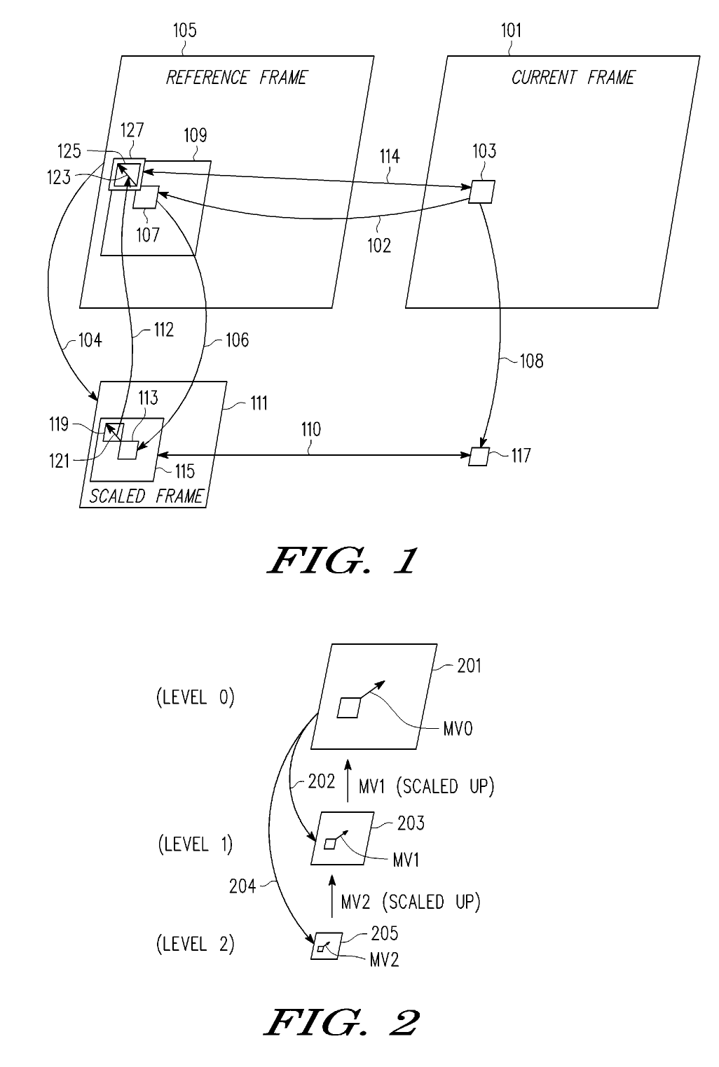

FIG. 1 is a figurative block diagram illustrating motion search of video information according to an exemplary embodiment. A current frame 101 represents a current frame of input video information to be encoder or currently being encoded. Each frame is generally encoded one macroblock (MB) at a time in which each MB is a 16×16 block of pixel values as understood by those skilled in the art. Each MB is encoded in “intra” mode in which a prediction MB is formed based on reconstructed MBs in the current frame, or “inter” mode in which a prediction MB is formed based on reference MBs from one or more reference frames. As shown, the current frame 101 includes a current MB 103 to be encoded in inter mode based on information from a reference frame 105, which is a video frame that has previously been encoded, decoded and reconstructed. The reference frame 105 may represent video information from a previous or future frame in the video sequence. The current frame 101 and the reference frame 105 are shown having the same size representing the same “operative” resolution with reference to a target number of pixels per frame for display. For purposes of simplicity and clarity of explanation, embodiments of the present invention are illustrated using the standard resolutions 4CIF (4× the common interface format or CIF) with 704 by 576 pixels per frame, CIF with 352 by 288 pixels per frame, and quarter CIF (QCIF) with 176 by 144 pixels per frame. Other standard (or non-standard) spatial resolutions are contemplated, such as QVGA, VGA, SVGA, D1, HDTV, etc.

The reference frame 105 includes a co-located MB 107 which is at the same relative position within the reference frame 105 as the position of the current MB 103 relative to the current frame 101 (as indicated by arrow 102). In many conventional encoding schemes for inter mode coding, a search window 109 is defined within the reference frame 105 relative to the co-located MB 107, or relative to a displaced MB (not shown) determined using a median motion vector of the surrounding MBs of the current MB 103. In one embodiment, the surrounding MBs are those MBs in the current frame 101 that are closest (or adjacent) to the current MB 103 in which a motion vector has already been determined, such as the left, top, top-right and top-left MBs relative to the current MB 103. The displaced MB is located relative to the co-located MB 107 using the median motion vector. Although search windows are depicted herein as being square, a search window may have other shapes (e.g., rectangular, circular, oval, etc.) Also, search patterns may be employed rather than a scanning pattern. A motion search may be conducted within the search window 109 relative to the current MB 103. During the search, the current MB 103 is compared to same-sized MBs within the search area 109 of the reference frame 105 using a comparison metric or the like in an attempt to find a reference MB that is within a predetermined threshold for the particular resolution or otherwise as close as possible to the current MB. In general, the closer the match, the greater the coding efficiency. In one embodiment, the absolute values of the differences between each pixel value of the current macroblock 103 of the current frame 101 being encoded and a corresponding pixel value of a search macroblock within the search window 109 of the reference frame 105 are summed together to determine a corresponding sum of absolute difference (SAD) metric. This calculation is repeated for each reference search macroblock in the search window (according to the selected motion search pattern) until a SUM value equal to or less than the predetermined threshold is found. If the threshold is not achieved, then the lowest or least SAD metric is determined as the minimum SAD or “MINSAD” metric for the motion search. In an alternative embodiment, a sum of square differences (SSD) metric is used instead of the SAD metric. In either case, the first comparison metric to meet the threshold or the minimum comparison metric determined during the search is used to identify the reference MB. The reference MB is then used for determining a motion vector (MV) between the co-located MB 107 and the reference MB, and the MV along with difference information between the current MB and the reference MB are encoded.

As the video resolution increases, the amount of displacement between consecutive frames in terms of pixel positions increases. As a result, the amount of information or number of pixels within the search window 109 increases which is typically due to the increased search window range as resolution increases. Stated another way, the number of pixels within a given relative search window size increases with increasing resolution. A large search window 109 may provide better coding efficiency for higher resolutions since the likelihood of a closer match with the current MB 103 increases. A larger search window, however, introduces greater computational complexity because the motion search process takes about 40%-60% of the computational load for a video encoder. The operative resolution of the current and reference frames 101 and 105 may be relatively high, such as 4CIF or the like, so that motion estimation may be prohibitively expensive in terms of power or processing resource consumption. Various methods are known for conducting the motion search within a specified search window. An exhaustive method starts with an MB located at the upper left corner of the search window 109 to determine a first comparison metric. Then the search MB is moved one pixel to the right and a new comparison metric is determined with the new search MB. This process is repeated across the entire top row of MBs of the search window 109 moving one pixel for each measurement. When the top row is completed all the way to the right side of the search window 109, the process shifts back to the left side but one pixel down from the top. Then the process is repeated for the row of MBs one pixel down from the top. Alternative methods are known, such as using different search window shapes or using different search patterns and the like which attempt to find an optimal reference MB with reduced computation. In either case, however, the higher the operative resolution of the frames and the larger the size of the search window 109, the greater the computational complexity of the motion search.

FIG. 1 illustrates a scalable motion search in which the reference frame 105 is reduced to a lower resolution or “scaled” frame 111 (as indicated by arrow 104). In one embodiment, the reference frame 105 is down-sampled and filtered (e.g., using a low-pass filter (LPF) or the like) to generate the scaled frame 111. As an example, a reference frame at 4CIF may be reduced to CIF or QCIF or more to significantly reduce the number of pixels per frame. The scaled frame 111 includes a starting video block 113 determined relative to the co-located MB 107 as indicated by arrow 106. The starting video block 113 may be a “co-located” video block at the same relative position within the scaled frame 111 as the co-located MB 107 within the reference frame 105. Alternatively, the starting video block 113 is a video block which is co-located relative to a displaced MB (not shown) relative to the co-located MB 107 employing the median motion vector (not shown) of the surrounding MBs of the current MB 103. It is noted that the starting video block 113 may loosely be referred to as a macroblock except that it includes less pixels. For example, for scaling from 4CIF to QCIF, an MB of 16×16 pixels within the reference frame 105 is scaled to a video block of only 4×4 pixels. A new search window 115 is defined within the scaled frame 111 surrounding the starting video block 113. As described further below, the search window 115 is determined using a predetermined offset range relative to the video block 113. The current MB 103 is also scaled down by the same amount to provide a scaled current video block 117 (as indicated by arrow 108). The motion search is performed in a similar manner by comparing the scaled current video block 117 with corresponding same-sized search video blocks within the search window 115 of the scaled frame 111 (as indicated by arrow 110) to find a reference video block that meets a threshold or has a minimum comparison metric.

The search window 115 may be selected to have the same relative size within the scaled frame 111 as the original search window 109 within the reference frame. If so, and if the scaled frame 111 is one-fourth the size of the reference frame 105, then the motion search is performed within the same relative area using only one-fourth the number of pixel calculations substantially reducing computational complexity. If the scaled frame 111 is one-sixteenth the size of the reference frame 105, then the computation complexity is reduced even more. In one embodiment, the relative size of the search window 115 may be made larger to cover a larger relative area of the scaled frame 111 as compared to the search window 109 relative to the reference frame 105 to improve motion search results. In the illustrated configuration, the scaled motion search in the scaled frame 111 produces a reference video block 119 and corresponding scaled motion vector 121 relative to the starting video block 113. The motion vector 121 is scaled up to the appropriate scale for the reference frame 105 (as indicated by arrow 112) identifying a corresponding starting reference MB 125 in the reference frame 105. If the comparison metric between the current MB 103 and the reference MB 125 meets the corresponding threshold defined for the operative resolution of the reference frame 105, then the motion search may be completed. Otherwise, or in addition, a new search window 127 relative to the starting reference MB 125 is defined within the reference frame 105 and a refined motion search is performed. As further described below, the search window 127 is determined with predetermined offset ranges relative to the starting reference MB 125. A “full-sized” motion search is performed comparing the current MB 103 with same-sized search MBs within the new search window 127 (as indicated by arrow 114). Although not shown, a new reference MB within the search window 127 may be determined to further adjust the accuracy of the motion vector 123.

It is appreciated that the scaled motion search in the scaled frame 111 is somewhat less accurate than the full scale search within the reference frame 105. Nonetheless, the scaled motion search provides sufficiently accurate results at the scaled level using substantially reduced computational complexity. Then, the results of the scaled motion search are scaled back up to the operative resolution of the reference frame 105 by scaling the scaled motion vector 121 up to the full scale motion vector 123. Furthermore, a reduced full-scale motion search is conducted within the smaller search window 127 of the reference frame 105 to further refine the motion search and potentially improve motion search accuracy. Since the motion search window 127 within the reference frame 105 is substantially reduced relative to the original search window 109 within the reference frame 105, and a reduced scale search is conducted within the scaled frame 111, similar accuracy may be achieved with substantially reduced computational complexity as compared to a full scale motion search within the search window 109.

FIG. 2 is a figurative block diagram illustrating scaled motion search of video information using multiple resolution levels according to an exemplary embodiment. A reference frame 201 is shown representing a full scale frame at a selected operative resolution level, shown as resolution level “0”. In one embodiment, the reference frame 201 at resolution level 0 is scaled down (as indicated by arrow 202) to an intermediate resolution level, shown as resolution level “1”, to produce an intermediate level reference frame 203. In a similar manner as described above with respect to FIG. 1, a scaled search is conducted within the reference frame 203 at intermediate resolution level 1 producing a scaled motion vector MV1, which is scaled back up to a full-scale motion vector MV0 within the reference frame 201. In this case, MV0 initially represents a scaled version of MV1. A reduced full scale motion search is then performed in the reference frame at resolution level 0 within a search window (not shown) determined by the full scale motion vector MV0. Depending upon the results of the full scale search, the motion vector MV0 may be further adjusted or refined. The process between levels 0 and 1 is substantially similar to that shown and described in FIG. 1.

In an alternative embodiment, the reference frame 201 at resolution level 0 is scaled down (as indicated by arrow 204) to a low resolution level, shown as resolution level “2”, to produce a low resolution reference frame 205. A scaled search is conducted within the low resolution reference frame 205 at low resolution level 2 producing a scaled motion vector MV2. In one embodiment, the scaled motion vector MV2 may be scaled immediately back up to the full scale motion vector MV0 within the reference frame 201 at resolution level 0 (thereby skipping the intermediate resolution level 1 altogether). In this case, the motion vector MV0 initially represents a scaled version of MV2. A reduced full scale motion search is then performed in the reference frame 201 at resolution level 0 within a search window (not shown) determined by the MV0. Again, depending upon the results of the full scale search, the motion vector MV0 may be further adjusted or refined. The process between levels 0 and 2 is substantially similar to that shown and described in FIG. 1.

In another embodiment, the motion vector MV2 at the low resolution level 2 is instead scaled to the intermediate resolution level 1 to the motion vector MV 1, and a search is conducted within the reference frame 203 at the intermediate resolution level 1. In this case, the intermediate motion vector MV1 initially represents a scaled version of MV2. An intermediate resolution motion search is then performed in the reference frame 203 at resolution level 1 within a search window (not shown) determined by the MV1, and MV1 is further refined or adjusted based on the search results at the intermediate resolution level 1. The process between levels 1 and 2 is substantially similar to that shown and described in FIG. 1. The adjusted MV1 is then scaled up to the motion vector MV0, which in this case represents a scaled version of the refined MV1 (as modified based on the intermediate level motion search). Finally, a full scale motion search is performed at resolution level 0 using the MV0 to further refine the motion search results. The process between levels 0 and 1 is substantially similar to that shown and described in FIG. 1.

As noted above, there are several possible variations for multiple resolution motion search to reduce computational complexity. If it is desired to reduce computations by a maximal amount, then the reference frame may be scaled down by a maximal amount, such as directly to resolution level 2 or below, and motion search at intermediate levels may be skipped and the results at the lowest scale are scaled to the operative resolution level directly. If additional computational power is available and additional accuracy is desired, motion search is performed at one or more intermediate resolution levels (e.g., level 1). Furthermore, the relative sizes of the search windows at each level may be adjusted. As described further below, at least one motion search offset range is provided for each resolution level. Furthermore, multiple levels of a search range scale are defined to provide corresponding multiple motion search offset ranges for each resolution level. Relative computational complexity is adjusted by adjusting the level of the search range scale to adjust the motion search offset ranges. As described further below, one or more operating metrics are monitored to adjust the search range scale, which in turn adjusts computational complexity.

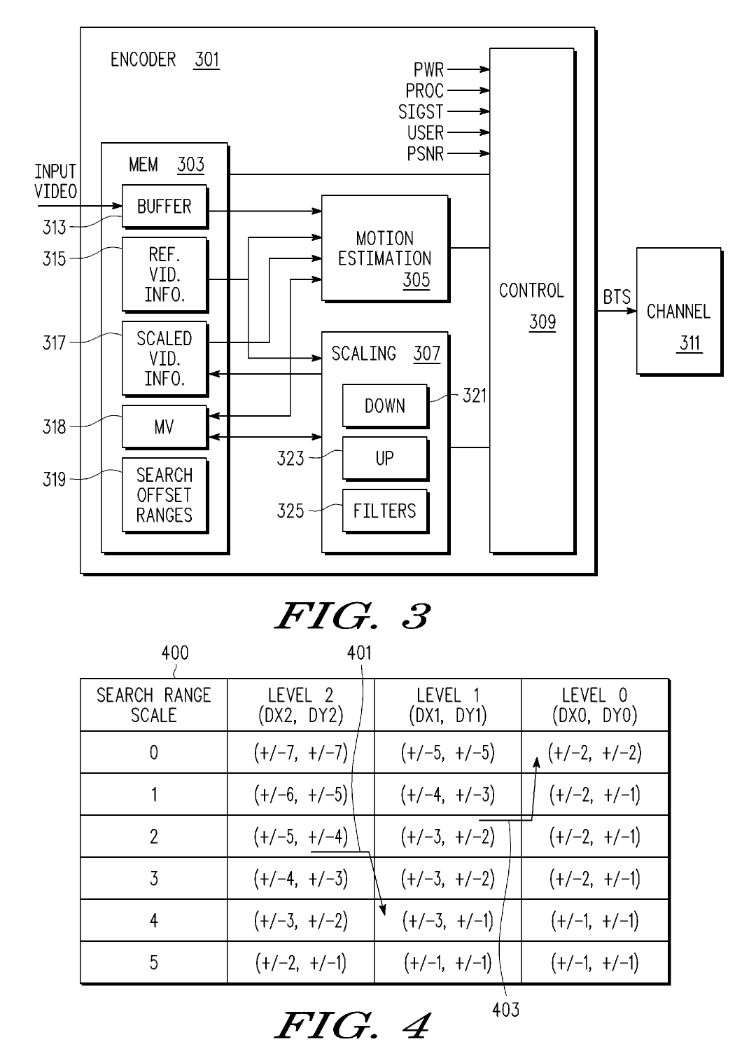

FIG. 3 is a simplified block diagram of an encoder 301 for performing scaled motion searches according to an exemplary embodiment. The encoder 301 includes a control circuit 309 coupled to a memory 303, a motion estimation (ME) circuit 305, and a scaling circuit 307. The memory 303 may be implemented as any combination of memory devices, such as random access memory (RAM) or read-only memory (ROM) and various other forms of memory devices (e.g., electrically-erasable programmable ROM or EEPROM, flash memory, etc.). Although the memory 303 is shown as a single block incorporated within the encoder 301, it may be implemented with multiple memory devices distributed in a video system incorporating the encoder 301. Also, although the memory 303 is shown as part of the encoder 301, it is understood that the memory 303 may be implemented as separate memory devices external to the encoder 301. The encoder 301 encodes video information into a bitstream BTS asserted on a channel 311. The channel 311 may be any media or medium in which wired and wireless communications are contemplated. Although not shown, the bitstream BTS is transmitted to a corresponding compatible decoder receiving communications via the channel 311. In one embodiment, an encoder and a decoder are incorporated within a signal transceiver device. It is understood that various other functional blocks and circuitry may be included for the encoder 301 although not shown, such as transform circuitry, quantization circuitry, intra prediction circuitry, entropy coding circuitry, scan circuitry, deblock filtering circuitry, etc.

Raw input video is received in a buffer 313 within the memory 303 and provided to an input of the ME circuit 305. During the encoding process, reference video information 315, such as including reference frames and the like, is stored in the memory 303 and available to respective inputs of the ME circuit 305 and the scaling circuit 307. The scaling circuit 307 includes a down sampler 321 and filters 325 for scaling down the resolution of the reference video information 315 to scaled video information 317 stored into the memory 303. In one embodiment, the filters 325 include one or more low-pass filters for filtering down sampled information for generating lower resolution frames. For example, the down sampler 321 and the filters 325 receive the reference frame 201 and generate the intermediate resolution reference frame 203 or the low resolution reference frame 205. The down sampler 321 and the filters 325 are further used to scale down the current MB to a corresponding scaled current video block used during motion search (e.g., current MB 103 scaled down to the scaled current video block 117 as previously described). The scaling circuit 307 further includes an up sampler 323 for scaling video information from lower resolution to higher resolutions, such as, for example, scaling the motion vectors MV1 and MV2 as previously described. In one exemplary embodiment, for example, the ME circuit 305 generates motion vectors which are stored into an MV portion 318 of the memory 303. The up sampler 323 of the scaling circuit 307 scales MVs generated for lower resolution frames up to corresponding MVs for higher resolution frames. The ME circuit 305 retrieves the scaled MVs from the MV portion 318 of the memory 303 for performing motion searches at higher resolution levels as previously described.

The control circuit 309 controls operation of the encoder 301 while coding video information into the bitstream BTS. The memory 303 further stores motion search offset ranges 319 available to the control circuit 309 for determining motion search windows used by the ME circuit 307. Power management circuitry (not shown) within the encoder 301 monitors various operating metrics, including the power level or available power (e.g., battery level) via a power metric PWR, available processing resources via a processing metric PROC, a signal strength metric SIGST indicating the signal strength of the bitstream BTS, a peak signal to noise ratio (PSNR) metric indicating the relative quality of the signal, and one or more user settings collectively indicated by a user metric USER. The PROC metric indicates available processing resources, such as an indication of available processor cycles or available memory resources or the like. The SIGST metric indicates the relative power level of the signal provided to the receiver. In a wireless configuration, for example, if the receiver is relatively close to the transmitting antenna then the SIGST should be relative high whereas if the receiver is relatively far from the antenna then the SIGST metric should be relatively low. The PSNR metric indicates the relative strength of the communication signal compared to the noise in the signal. In a system employing motion estimation, the relative accuracy of prediction of the motion vectors affects the quality of the video image as indicated by the PSNR metric. The higher the quality of motion prediction the higher the value of the PSNR metric and vice-versa. In the encoder 301, the PSNR metric may be based on an actual PSNR measurement or a determination of an equivalent metric. The USER metric incorporates manual settings and adjustments made by the user of the video device incorporating the encoder 301, such as an adjustment for visual quality or the like. These operating metrics are provided to the control circuit 309 for determining the parameters of motion search performed by the ME circuit 305. The ME circuit 307 performs the motion searches during inter coding mode. In one embodiment, when sufficient resources and power are available, the control circuit 309 instructs the ME circuit 305 to perform motion searches directly within the reference frames and bypasses scaled motion searches. When limited resources are available, such as low power or overloaded processing resources in a hand held device or reduced signal transmission quality, etc., or in response to particular user settings such as to conserve processing capacity or power, the control circuit 309 instructs the scaling circuit 307 to scale the resolution of the reference frame and the current MB to a lower resolution level relative to the operative resolution level, and to store the scaled video information 317 within the memory 303. The control circuit 309 determines the level of scaling, the number of resolution levels to provide, and whether motion searches are performed at intermediate resolution levels. The control circuit 309 further uses the motion search offset ranges 319 to determine the relative sizes of the search windows for each of the resolution levels used.

FIG. 4 is a table 400 illustrating an exemplary embodiment of the motion search offset ranges 319. In one embodiment, the motion search offset ranges 319 may be implemented within a lookup table or the like within the memory 303. The control circuit 309 retrieves selected motion search offset ranges 319 for determining the size of the search windows during scaled motion searches performed by the ME circuit 305. The illustrated table 400 includes a search range scale and corresponding motion search offset ranges at each of three separate resolution levels 0, 1 and 2. The resolution level 0 represents the highest or operative resolution level used by the encoder 301 and includes search offset range DX0 for the horizontal or “X” direction and DY0 for the vertical or “Y” direction for the operative resolution level 0. The resolution level 1 represents an intermediate resolution level used by the encoder 301 and includes search offset range DX1 for the horizontal direction and DY1 for the vertical direction for the intermediate resolution level 1. Likewise, the resolution level 0 represents a low resolution level used by the encoder 301 and includes search offset range DX2 for the horizontal direction and DY2 for the vertical direction for the low resolution level 1. Six different levels of the search range scale, numbered 0 to 5, are shown to provide a corresponding six offset ranges for each resolution level. Each offset range is shown having a range between positive and negative values inclusive, e.g., offset range DX2 is shown as having a value “±7” which represents a range of −7 to +7 including a range of 15 pixels in the horizontal direction. Since the offset range DXY is also “±7”, the search window is 15×15 pixels relative to a starting video block within the resolution level 2 reference frame.

In one embodiment, each successive lower resolution level is scaled by a factor of two (2) in both horizontal and vertical directions thereby reducing the frame size by a factor of four (4) from one level to the next (e.g., level 0 is 4CIF, level 1 is CIF, and level 2 is QCIF). In this manner, the co-located or starting 16×16 MB in the reference frame at the operative resolution level 0 is reduced to an 8×8 video block in the intermediate resolution level 1 and to a 4×4 video block in the low resolution level 2. The search window at the low resolution level 2 is 15×15 pixels relative to a starting video block of 4×4 pixels in the low resolution reference frame. The search range of ±7, ±7 for a 15×15 search window at level 2 corresponds to a search range of ±14, ±14 for a 29×29 search window at the intermediate resolution level 1 with a corresponding starting video block of 8×8 pixels. This same search range further corresponds to a search range of ±28, ±28 for a 57×57 search window at level 0 with a starting MB size of 16×16 pixels. It is noted, therefore, that a motion search at the low resolution level 2 has a significantly lower computation cost as compared to a “comparable” motion search at the higher resolution levels, in which “comparable” is based on the size of the search window relative to the frame size. Also, the search offset ranges are smaller at the higher resolution levels. For example, at the search range scale of “0”, the offset ranges at level 2 are each ±7, the offset ranges at level 1 are each ±5, and the offset ranges at level 0 are each ±2. Thus, the relative motion search window is significantly reduced at the higher resolution levels. Furthermore, the offset ranges in the vertical direction are smaller for certain search range scales than those in the horizontal direction. For example, at resolution level 2 and search range scale 2, the DX2 value is ±5 whereas the DY2 value is ±4. This difference is due to the general observation that most motion occurs more often in the horizontal direction than in the vertical direction. In one embodiment, the offset ranges were those that increased or maximized PSNR over a target bandwidth signal range for video ranging from low motion to high motion.

The control circuit 309 monitors the operating metrics (e.g., PWR, PROC, SIGST, PSNR, USER) and determines the available processing power and resources and determines the motion search method. The control circuit 309 determines, for example, whether to perform scaled motion searching, and if so, which lower resolutions to use and which level of the search range scale to use to determine the search window size at each resolution level. As an example, assume that the control circuit 309 determines to use both resolution levels 1 and 2 at level 2 of the search range scale. In this example, the control circuit 309 instructs the scaling circuit 307 to scale the reference frame and the current MB down to the low resolution level 2 and determines a search window relative to the co-located or displaced video block based on the offset ranges DX2=±5 and DY2=±4. The control circuit 309 instructs the ME circuit 305 to perform the scaled motion search at resolution level 2 using the determined search window, and the ME circuit 305 generates and stores a corresponding motion vector in the MV portion 318 of the memory 303. The control circuit 309 instructs the scaling circuit 307 to scale the motion vector at resolution level 2 to a corresponding motion vector for resolution level 1. The control circuit 309 further instructs the scaling circuit 307 to scale the reference frame and the current MB to resolution level 1, identifies the corresponding starting search video block from the level 1 MV and a co-located video block (co-located relative to the co-located or displaced video block at the lower level). Then the control circuit 309 then determines a search window relative to the starting search video block based on the offset ranges DX1=±3 and DY2=±2. It is noted at this point that the relative search window at resolution level 1 is substantially reduced compared to the relative search window for resolution level 2.

The control circuit 309 then instructs the ME circuit 305 to perform a motion search at resolution level 1 and determines a corresponding motion vector. In this case, the new motion vector at resolution 1 is an updated or refined version of the motion vector originally scaled up from the scaled search performed at resolution level 2. The scaling circuit 307 then scales the modified motion vector at level 1 to a corresponding motion vector for resolution level 0. The control circuit 309 then determines a starting search MB using the co-located MB in the original reference frame and the refined motion vector scaled up to level 0. Then the control circuit 309 determines a search window relative to the starting search MB in the reference frame based on the resolution level 0 offset ranges DX1=±2 and DY2=±1 (still at level 2 of the search range scale). It is again noted at this point that the relative search window at resolution level 0 is substantially reduced compared to the relative search window for resolution level 1. The ME control circuit 307 then performs the full scale motion search at resolution level 0 and determines the final motion vector for the motion search. The final motion vector is encoded and the resulting reference MB information is used together with the current MB for purposes of encoding the current MB.

Several variations may be employed during the scaled motion search. If at any time during motion estimation the operating metrics indicate a reduction of the resources, the control circuit 309 may determine to omit motion search at the intermediate level and scale directly to the operative resolution level 0. Furthermore, the control circuit 309 may modify the level of the search range scale to further reduce the offset ranges on-the-fly. For example, at the beginning of the intermediate resolution level 1 motion search while determining the search window using level 2 of the search range scale, the control circuit 309 may modify the search range scale to level 4 and use the offset ranges DX1=±2 and DY2=±1 instead as indicated by arrow 401 within the table 400. Alternatively, if the operating metrics indicate an increase in resource availability during the motion search, the number of resolution levels may be increased and/or the level of the search range scale may be modified on-the-fly to increase the search range window sizes. For example, when scaling up to resolution level 0 from resolution level 1 at an original search range scale of level 2, the control circuit 309 may adjust the level of the search range scale on-the-fly to level 0 and use instead the offset ranges DX1=±2 and DY2=±2 as indicated by arrow 403 within the table 400.

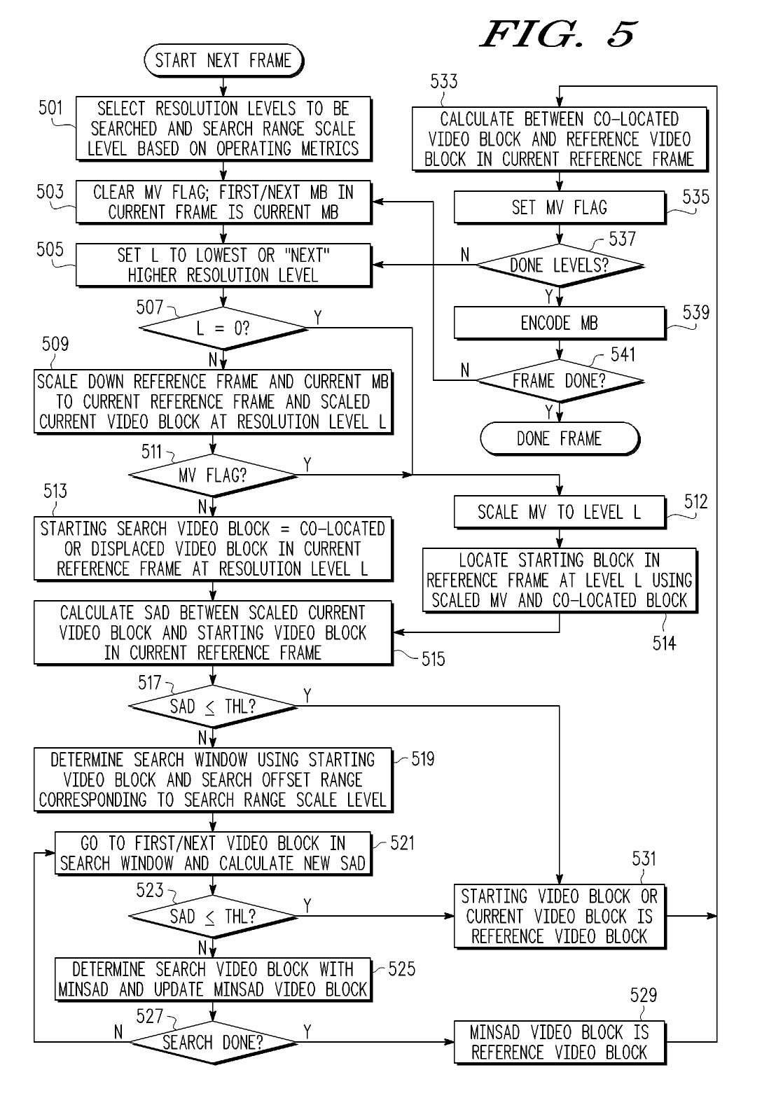

FIG. 5 is a flowchart diagram illustrating operation of the encoder 301 for performing scaled motion searches according to one embodiment. The flowchart diagram illustrates operation for encoding a frame during inter code mode using scaled motion search. For each new frame to be encoded, operation begins at a first block 501 in which the control circuit 309 determines the level of the search range scale and which resolution levels are to be searched based on the operating metrics being monitored. The search range scale and the resolution levels to be searched may be adjusted on-the-fly at any time during the encoding process based on changes of the operating metrics as previously described. Operation then proceeds to block 503 in which an MV flag is cleared and the next MB in the current frame (or the first MB in first iteration) to be encoded is set as the current MB. The MV flag is a binary indicator of whether a motion vector has been generated for the current MB as further described below. Operation proceeds to block 505 in which motion search operation advances to the lowest resolution level or the next higher resolution level “L” depending upon the position in processing. In the first iteration, operation proceeds to the lowest resolution level L which had previously been determined at block 501. For example, if the control circuit 309 determined that motion search was to be performed for levels 0, 1 and 2, then the resolution level L is initially set to 2 and during each successive execution of block 505, operation proceeds to the next higher resolution level L (e.g., 0→2→1→0) until the motion search at the operative resolution level (L=0) is reached.

Operation advances to block 507 in which it is queried whether the resolution level L is the top level, or whether L=0. In the first iteration after L is set to the lowest resolution level and after each successive iteration in which L is higher than “0”, operation advances to block 509 in which the reference frame and the current MB at the highest operative resolution level are both scaled down by the scaling circuit 307 to a “current” reference frame and a scaled current video block at the resolution level L. As previously described, for example, the reference frame 105 is scaled down to the scaled frame 111 and the current MB 103 is scaled down to the scaled current video block 117. Operation then advances to block 511 to check the status of the MV flag. In the first iteration, the MV flag is still cleared (having been cleared at block 503) so that operation proceeds to block 513 in which the starting search video block within the current reference frame at the current resolution level L (generated at block 509) is set to the video block that is co-located in relative position with the current MB within the current frame, that is, a relative (0,0) motion vector between the current MB in the current frame and the starting MB in the reference frame, or the starting block is set to the video block that is displaced relative to the co-located block based on a median motion vector. As previously described, the median motion vector is determined from the motion vectors determined for surrounding MBs of the current MB. In one embodiment, for example, the median motion vector is applied to the co-located MB in the reference frame to determine a displaced MB at the operative level, and the starting video block is co-located relative to the displaced MB. At next block 515, the ME circuit 305 calculates a SAD metric between the scaled current video block and the starting video block in the current reference frame at resolution L. It is noted that the SAD metric is used in the illustrated embodiment as the comparison metric, although alternative comparison metrics are contemplated, such as SSD. It is also noted that motion may not be occurring in certain portions of the frame (or otherwise relatively small motion is occurring) so that the likelihood of the co-located video block having the lowest SAD metric or otherwise meeting the corresponding comparison threshold is relatively high. In this manner, a SAD metric is first calculated for the co-located video block or the displaced video block to potentially minimize computational complexity before proceeding with determining a motion window and searching therein.

Operation advances to block 517 in which the SAD metric determined at block 515 is compared with a threshold value THL suitable for the resolution level L. In the illustrated embodiment, a different threshold value THL is used for each resolution level L since computations at lower resolution levels involve a lower number of pixels. For resolution levels 0, 1 and 2, for example, threshold values TH0, TH1 and TH2 are defined. If the SAD metric is not less than or equal to the threshold value THL as determined at block 517, then operation proceeds to block 519 in which the search window for the current reference frame at resolution level L is determined using the starting block and the search offset ranges corresponding to the applicable search range scale level. For example with reference to table 400, the search offset ranges DX2=±7 and DY2=±7 are used at resolution level 2 and search range scale level 0. Operation then advances to block 521 in which the ME circuit 305 initiates a motion search within the search window. The ME circuit 305 proceeds to compare the first or next search video block in the determined search window and generates a corresponding new SAD metric. Operation then advances to block 523 in which the SAD metric determined at block 521 is compared with the threshold value THL in a similar as in block 517. If the new SAD metric does not meet the threshold value THL at block 523, then operation proceeds to block 525 to determine the search video block having the least SAD metric (MINSAD) so far during the motion search. In one embodiment, the first two SAD metrics determined at blocks 515 and 521 are compared and the lowest SAD is initially set to the MINSAD by default. Subsequently, while the threshold value THL is not met, each subsequent new SAD metric that is determined is compared to the current MINSAD and MINSAD is set to the lesser SAD metric.

Operation advances to block 527 in which it is queried whether the motion search in the current search window has been completed. If additional video blocks remain to be searched in the search window, then operation returns to block 521 in which the ME circuit 305 advances to the next search video block in the search window and calculates a new SAD metric, which is compared with the threshold value THL at next block 523. Operation loops between blocks 521 and 527 until the threshold value THL is met as determined at block 523 or until the motion search is completed as determined at block 527. If the motion search is completed without meeting the threshold value THL, then operation advances to block 529 in which the video block having the MINSAD metric is determined to be the reference video block. Otherwise, if during the motion search a video block meeting the threshold value THL is determined at block 523, then operation advances instead to block 531 in which the current search video block is determined to be the reference video block. Referring back to block 517, if the SAD metric for the initial starting search video block (or the co-located video block) had met the threshold value THL, then operation proceeds directly to block 531 in which the initial starting video block is determined to be the reference video block.

After the reference video block is determined at either of blocks 529 or 531, operation advances to block 533 in which a motion vector MV is calculated between the co-located video block and the reference video block in the current reference frame. It is noted that the MV may be (0,0) if the co-located video block met the threshold value THL in the first place. In the illustrated embodiment, an MV=(0,0) is used in a similar manner as a non-zero MV. Operation then advances to block 535 to set the MV flag indicating that an MV has been determined. Operation then proceeds to block 537 to query whether all of the resolution levels determined at block 501 (a potentially modified based on the operating metrics) have been searched. If more levels including the operative resolution remain to be searched for the current MB, then operation proceeds back to block 505 to advance to the next highest resolution level. Operation loops between blocks 505 and 535 until each resolution level to be searched is completed including the operative or highest resolution level. In each subsequent iteration after the first in which the MV flag has been set at block 535, operation proceeds to block 512 from block 511 (rather than block 513). At block 512, the MV calculated at block 533 is scaled up to the next higher resolution level L (in which L was updated at block 505). Operation then proceeds to block 514 in which the MV is applied to the current reference frame for resolution level L, and the starting video block in the current reference frame is determined using the scaled MV and the co-located video block. Operation then proceeds to block 515 to calculate the SAD metric for the starting video block as previously described (block 513 is skipped since using a starting video block determined with the MV rather than the co-located or displaced video block). When the top or operative resolution level is reached as determined at block 507, operation proceeds directly to block 512 and block 509 is also skipped since the operative resolution frame and current MB do not need to be scaled down.

When all of the resolution levels have been searched for the current MB as determined at block 537, operation proceeds to block 539 in which the current MB is encoded using the final MV calculated at block 533. The final MV is used to identify a reference MB relative to the co-located MB in the reference frame at the operative resolution. In one embodiment, for example, the final MV is encoded along with difference information between the corresponding reference MB in the reference frame and the current MB in the current frame. Operation then advances to block 541 to determine whether coding of the current frame has been completed. If so, then operation is completed for the current frame. Otherwise, operation loops back to block 503 in which the MV flag is cleared and operation advances to the next MB in the current frame. Operation loops between blocks 503 and 541 until the current frame is encoded.

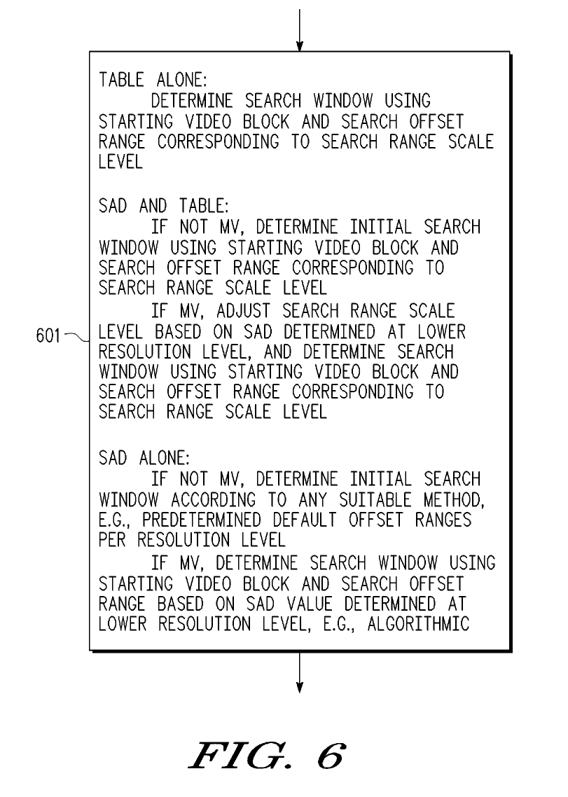

FIG. 6 is a diagram of a replacement block 601 for block 519 of the flowchart of FIG. 5 for an alternative embodiment in which the motion search comparison metric determined at a lower resolution level is used to adjust or otherwise determine the size of the motion search window at a higher resolution level. In FIGS. 5 and 6, the comparison metric used is the SAD metric, although it is understood that any suitable alternative motion search comparison metric may be used, such as, for example, the SSD metric. The flowchart of FIG. 5 and operation is substantially the same except that block 519 is replaced with block 601. At block 601, if the table 400 of motion search offset ranges is available and to be used alone for determining the search window (denoted “TABLE ALONE”), then the search window for the current reference frame at resolution level L is determined using the starting block and the search offset ranges corresponding to the applicable search range scale level in the same manner as previously described for block 519.

Alternatively, if the table 400 of motion search offset ranges is available and to be used in combination with the SAD metric (denoted “SAD AND TABLE”), then operation is similar except that the search range scale level is adjusted based on the SAD metric. In the first iteration, a SAD metric has not yet been determined (MV flag cleared) so that the table 400 is used in the same manner. The MV flag is used to determine the first iteration so that if the MV flag is not yet set, then the table 400 is used alone to determine the first motion search window. In subsequent iterations however, a SAD metric and the MV flag is set, and the SAD determined at the lower resolution level is used to adjust the search range scale level in a similar manner as previously illustrated by arrows 401 and 403. In particular, if the SAD metric is relatively small indicating a relatively accurate motion vector, then the search range scale level may be reduced to correspondingly reduce the motion search offset range thereby reducing the motion search window. On the other hand, if the SAD metric is relatively large possibly indicating a somewhat inaccurate motion vector, then the search range scale level may be increased to correspondingly increase the motion search offset range thereby increasing the motion search window. In yet another embodiment, any adjustment to the search range scale level may be tempered or otherwise limited by the operating metrics being monitored by the control circuit 309. For example, if the SAD metric is relatively high such that it might otherwise be indicated to increase the search range scale level by two, the increase might be limited to zero or one if the operating metrics otherwise indicate that the computation complexity should be minimized.

Alternatively, if the table 400 of motion search offset ranges is not available or otherwise not used (denoted “SAD ALONE”), then it is indicated that the motion search window be determined primarily based on the SAD metric. In the first iteration (MV flag cleared), a SAD metric has not yet been determined so that the initial motion search window is determined according to any suitable method. In one embodiment, a predetermined default offset range may be used to determine the search window for the first iteration at the lowest resolution level. In one embodiment, at least one predetermined default offset range may be provided for each resolution level and stored in the memory 303. For example, the motion search offset ranges 319 may be replaced with the default offset ranges. In another embodiment, it is appreciated that the offset ranges in the table 400 may be used as suitable default offset ranges as is or adjusted accordingly. In this manner, the default values may further vary based on a selected search range scale if desired. In subsequent iterations for higher resolution levels after the MV flag is set, the search window is determined using the starting video block as usual and with the search offset range determined based on the SAD metric previously determined. A predetermined formula or algorithm is contemplated for determining the motion search window for each resolution level based on the SAD metric determined at a lower resolution level. The larger the SAD value, the larger the motion search window. The formula or algorithm may incorporate one or more of the operating metrics or otherwise the determined window size is adjusted based on the operating metrics to ensure computation complexity is not excessive.

A method of performing motion search for video information according to one embodiment includes providing at least one motion search offset range for each of multiple levels of a search range scale and for each of multiple resolution levels, where the resolution levels include an operative resolution level and at least one reduced resolution level, monitoring at least one operating metric, selecting one of the levels of the search range scale based on the at least one operating metric, and performing motion search at each of the at least one reduced resolution level and the operative resolution level using corresponding search windows determined using a corresponding one of the motion search offset ranges at the selected search range scale level. The operating metric may provide an indication of available processor resources or available power or signal strength or user settings or the like.

The method may further include scaling a reference frame and a current macroblock at the operative resolution level down to a selected reduced resolution level, performing motion search at the selected reduced resolution level using a motion search window determined by a motion search offset range corresponding with the selected reduced resolution level and the selected search range scale level to determine a motion vector at the selected reduced resolution level, scaling the motion vector up to a higher resolution level to provide a scaled motion vector, and repeating the scaling a reference frame, and performing motion search and scaling the motion vector until the motion vector is scaled for the operative resolution level.

The method may further include determining a starting macroblock at the operative resolution level using the scaled motion vector, and using a motion search window determined by at least one motion search offset ranges corresponding to the operative resolution level.

The method may include providing a horizontal offset range and a vertical offset range for each resolution level. Multiple reduced resolution levels may be determined, in which the method may further include performing motion search for selected reduced resolution levels based on the at least one operating metric. The method may include providing at least one motion search offset range for each of multiple search range scale levels and for each resolution level. The method may include selecting another one of the levels of the search range scale based on a change of the at least one operating metric. The method may further include determining a comparison metric during each motion search, and adjusting the level of the search range scale based on at least one determined comparison metric.

A video encoder according to an exemplary embodiment includes a memory, a motion estimation circuit, a scaling circuit and control logic. The memory stores predetermined motion search offset ranges including at least one motion search offset range for each of multiple resolution levels at each of multiple levels of a search range scale. The motion estimation circuit performs a motion search at any selected resolution level. The scaling circuit scales video information between resolution levels. The control logic monitors at least one operating metric, selects a search range scale level based on the operating metric, causes the scaling circuit to scale video information between selected resolution levels and causes the motion estimation circuit to perform a motion search at each selected resolution levels using a corresponding search window determined by a corresponding motion search offset range at the selected search range scale level.

Each motion search offset range may include a horizontal offset range and a vertical offset range. In one embodiment, the vertical offset range is less than the horizontal offset range for at least one motion search offset range. The control circuit may select a search range scale level and any number of resolution levels to search based on at least one operating metric. The control circuit may select another search range scale level in response to a change of the at least one operating metric. The control circuit may change a selection of resolution levels in response to a change of the at least one operating metric. Several operating metrics may be provided for indicating available resources or user settings, such as available processing resources, available power, signal strength, etc. The motion estimation circuit may further determine a comparison metric during motion search, and the control circuit may further adjust the selected level of the search range scale based on the comparison metric.

A method of performing motion search for video information according to another embodiment includes performing motion search at each of at least one reduced resolution level and an operative resolution level, determining a comparison metric while performing motion search, and using the comparison metric determined for one reduced resolution level to determine size of a motion search window at a higher resolution level. The method may include providing at least one motion search offset for each resolution level and using a corresponding motion search offset to determine a motion search window during an initial motion search. The method may further include providing a motion search offset range for each of multiple levels of a search range scale and for each of multiple resolution levels, selecting one of the levels of the search range scale based on at least one operating metric, and adjusting the level of the search range scale based on the comparison metric.

Although the present invention has been described in considerable detail with reference to certain preferred versions thereof, other versions and variations are possible and contemplated. For example, circuits or logic blocks described herein may be implemented as discrete circuitry or integrated circuitry or software or any alternative configurations. Those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A method of performing motion search for video information, comprising:
providing a plurality of motion search offset ranges including at least one motion search offset range for each of a plurality of levels of a search range scale and for each of a plurality of resolution levels which comprises an operative resolution level and at least one reduced resolution level;
monitoring at least one operating metric;
selecting one of the levels of the search range scale based on the at least one operating metric; and
performing motion search at each of the at least one reduced resolution level and the operative resolution level using corresponding search windows determined using a corresponding one of the plurality of motion search offset ranges at the selected search range scale level.

2. The method of claim 1, wherein said performing motion search at the at least one reduced resolution level, comprises:
scaling a reference frame and a current macroblock at the operative resolution level down to a selected one of the at least one reduced resolution level;
performing motion search at the selected reduced resolution level using a motion search window determined by at least one of the plurality of motion search offset ranges corresponding with the selected reduced resolution level and the selected search range scale level to determine a motion vector at the selected reduced resolution level;
scaling the motion vector up to a higher resolution level to provide a scaled motion vector; and
repeating said scaling a reference frame, said performing motion search and said scaling the motion vector until the motion vector is scaled for the operative resolution level.

3. The method of claim 2, wherein said performing motion search at the operative resolution level comprises:
determining a starting macroblock at the operative resolution level using the scaled motion vector; and
using a motion search window determined by at least one of the plurality of motion search offset ranges corresponding to the operative resolution level and the selected search range scale level.

4. The method of claim 1, wherein the at least one reduced resolution level comprises a low resolution level and an intermediate resolution level, and wherein said performing motion search at the at least one reduced resolution level comprises:
scaling the reference frame and the current macroblock down to the low resolution level;
performing motion search at the low resolution level using a motion search window determined by at least one of the plurality of motion search offset ranges corresponding to the low resolution level and the selected search range scale level to determine a first motion vector for the low resolution level;
scaling the first motion vector up to the intermediate resolution level to provide a second motion vector for the intermediate level;
scaling the reference frame and the current macroblock down to the intermediate resolution level;
performing motion search at the intermediate resolution level using the second motion vector and using a motion search window determined by at least one of the plurality of motion search offset ranges corresponding to the intermediate resolution level and the selected search range scale level to determine a third motion vector for the intermediate resolution level; and
scaling the third motion vector up to the operative resolution level.

5. The method of claim 1, wherein said providing a plurality of motion search offset ranges comprises providing a horizontal offset range and a vertical offset range for each of the plurality of resolution levels.

6. The method of claim 1, wherein the at least one reduced resolution level comprises a plurality of reduced resolution levels, further comprising
performing motion search for selected ones of the plurality of reduced resolution levels based on the at least one operating metric.

7. The method of claim 1, wherein said monitoring at least one operating metric comprises monitoring at least one of available processing resources, available power, and signal strength.

8. The method of claim 1, further comprising:
said performing motion search comprising determining a comparison metric; and
adjusting the level of the search range scale based on at least one determined comparison metric.

9. The method of claim 1, further comprising selecting another one of the levels of the search range scale based on a change of the at least one operating metric.

10. A video encoder, comprising:
a memory which stores a plurality of predetermined motion search offset ranges comprising at least one motion search offset range for each of a plurality of levels of a search range scale at each of a plurality of resolution levels which comprises an operative resolution level and at least one lower resolution level;
a motion estimation circuit which performs a motion search at any selected one of said plurality of resolution levels;
a scaling circuit which scales video information between said plurality of resolution levels; and
control logic, coupled to said memory, said motion estimation circuit and said scaling circuit, which monitors at least one operating metric, which selects one of said plurality of levels of said search range scale based on said at least one operating metric, which causes said scaling circuit to scale video information between each of selected ones of said plurality of resolution levels, and which causes said motion estimation circuit to perform a motion search at each of said selected ones of said plurality of resolution levels using a corresponding search window determined by a corresponding one of said plurality of motion search offset ranges at said selected level of said search range scale.

11. The video encoder of claim 10, wherein each of said plurality of predetermined motion search offset ranges comprises a horizontal offset range and a vertical offset range.

12. The video encoder of claim 10, wherein said at least one lower resolution level comprises a plurality of lower resolution levels, and wherein said control circuit selects from among said plurality of lower resolution levels based on said at least one operating metric.

13. The video encoder of claim 12, wherein said control circuit selects another one of said plurality of levels of said search range scale in response to a change of said at least one operating metric.

14. The video encoder of claim 12, wherein said control circuit changes said selection of said plurality of lower resolution levels in response to a change of said at least one operating metric.

15. The video encoder of claim 12, wherein said at least one operating metric comprises at least one of available processing resources, available power, user setting, and signal strength.

16. The video encoder of claim 10, wherein said motion estimation circuit determines a comparison metric during motion search, and wherein said control circuit further adjusts said level of said selected level of said search range scale based on said comparison metric.

17. A method of performing motion search for video information, comprising:
performing motion search at each of at least one reduced resolution level and an operative resolution level;
determining a comparison metric during said performing motion search; and
using the comparison metric determined for one reduced resolution level to determine size of a motion search window at a higher resolution level.

18. The method of claim 17, wherein said determining a comparison metric comprises determining a sum of absolute differences between pixel values of a current video frame and pixel values of a reference video frame.

19. The method of claim 17, further comprising:
providing at least one motion search offset for each resolution level; and
using a corresponding motion search offset to determine a motion search window during an initial motion search.

20. The method of claim 17, further comprising:
providing a motion search offset range for each of a plurality of levels of a search range scale and for each of a plurality of resolution levels;
selecting one of the levels of the search range scale based on at least one operating metric; and
wherein said using the comparison metric determined for one reduced resolution level to determine size of a motion search window at a higher resolution level comprises adjusting the level of the search range scale based on the comparison metric.
